(19) United States
(12) Patent Application Publication
(10) Pub. No.: US 2025/0351152 A1
(43) Pub. Date: Nov. 13, 2025

(54) APPARATUS AND METHOD FOR WIRELESS COMMUNICATIONS HAVING MULTIPLE DOWNLINK CONTROL INFORMATION STAGES

(71) Applicant: Lenovo (Singapore) Pte. Ltd., New Tech Park (SG)

(72) Inventors: Prateek Basu Mallick, Dreieich (DE); Karthikeyan Ganesan, Kronberg im Taunus (DE); Joachim Löhr, Wiesbaden (DE); Alexander Golitschek Edler von Elbwart, Darmstadt (DE)

(21) Appl. No.: 18/658,730

(22) Filed: May 8, 2024

(51) Int. Cl. H04W 72/232; H04W 68/02; H04W 72/1273; H04W 76/20

(52) U.S. Cl. CPC H04W 72/232; H04W 68/02; H04W 72/1273; H04W 76/20

(57) ABSTRACT

Various aspects of the present disclosure relate to methods, apparatuses, and devices for wireless communication. A user equipment (UE) may receive one or more first stage downlink control information (DCI). The UE may receive a second stage DCI. The UE may determine whether a UE bit is set to true in the second stage DCI. The UE may determine physical downlink shared channel (PDSCH) resources from the one or more first stage DCI. The UE may receive a radio resource control (RRC) paging message based on the PDSCH resources included in the one or more first stage DCI. The UE may determine whether a paging record of the UE is included in the RRC paging message. The UE may forward the paging record to an upper layer of the UE in response to determining that paging record of the UE is included in the RRC paging message.

### TECHNICAL FIELD

The present disclosure relates to wireless communications, and more specifically to wireless communications having multiple downlink control information (DCI) stages.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Various aspects of the present disclosure relate to wireless communications, including improved methods and apparatuses that support wireless communications having multiple DCI stages. A UE may receive one or more first stage DCI. The UE may also receive a second stage DCI. The UE may determine whether a UE bit is set to true in the second stage DCI. The UE may also determine physical downlink shared channel (PDSCH) resources from the one or more first stage DCI. The UE may receive a radio resource control (RRC) paging message based on the PDSCH resources included in the one or more first stage DCI. The UE may also determine whether a paging record of the UE is included in the RRC paging message. The UE may forward the paging record to an upper layer of the UE in response to determining that paging record of the UE is included in the RRC paging message.

### BRIEF DESCRIPTION OF THE DRAWINGS

FIG. 1 illustrates an example of a wireless communications system in accordance with aspects of the present disclosure.

FIG. 2 illustrates an example diagram of paging frames (PFs) and paging occasions (POs) when N=T/4 and Ns=4 in accordance with aspects of the present disclosure.

FIG. 3 illustrates another example diagram of PFs and POs in accordance with aspects of the present disclosure.

FIG. 4 illustrates a further example diagram of PFs and POs in accordance with aspects of the present disclosure.

FIG. 5 illustrates an example diagram of PFs and POs multiplexed in a frequency domain in accordance with aspects of the present disclosure.

FIG. 6 illustrates an example diagram of PFs and POs multiplexed in a frequency domain with one or more first stage POs and one or more second stage POs in accordance with aspects of the present disclosure.

FIG. 7 illustrates an example of paging DCI in accordance with aspects of the present disclosure.

FIG. 8 illustrates an example of an RRC paging message in accordance with aspects of the present disclosure.

FIGS. 9A, 9B, and 9C illustrate an example of a paging early indication (PEI) subgrouping method in accordance with aspects of the present disclosure.

FIG. 10 illustrates an example of a search space (SS) configuration in accordance with aspects of the present disclosure.

FIG. 11 illustrates an example of a UE in accordance with aspects of the present disclosure.

FIG. 12 illustrates an example of a processor in accordance with aspects of the present disclosure.

FIG. 13 illustrates an example of a network equipment (NE) in accordance with aspects of the present disclosure.

FIG. 14 illustrates a flowchart of a method performed by a UE in accordance with aspects of the present disclosure.

FIG. 15 illustrates a flowchart of a method performed by an NE in accordance with aspects of the present disclosure.

### DETAILED DESCRIPTION

Various aspects of the present disclosure relate to improved methods and apparatuses that support wireless communications having multiple DCI stages. Certain paging occasions (POs) and paging frames (PFs) may be spread over time thereby slowing down paging and/or using more system resources. Reducing the time used to transmit POs may reduce power consumption, reduce processor usage, reduce data usage, and increase overall system performance.

Aspects of the present disclosure are described in the context of a wireless communications system.

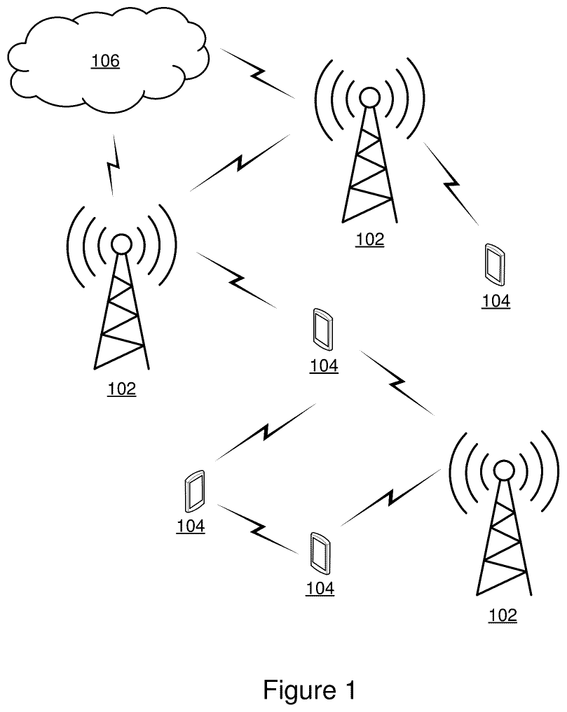

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with an NTN. In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a UE-to-UE interface (PC5 interface).

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHz-114.25 GHZ), FR4a or FR4-1 (52.6 GHz-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

Emissions and energy consumption from different elements of a telecommunication system may adversly contribute to the climate. Besides climate issues, operating expenses to run telecommunication services may be large. In telecoms, a number of industry-specific factors rooted in countering rising network costs may facilitate improving efficiency. There may be a continued rise in mobile data traffic, estimated at 6.4 GB per user per month in 2019 and forecast to grow threefold on a per-user basis over the next five years. This combined with the rising costs of the transmission spectrum, capital investment and ongoing radio access network (RAN) maintenance and/or upgrades, energy-saving measures in network operations may be necessary rather than nice to have. 5G new radio (NR) may offer a significant energy-efficiency improvement per gigabyte over previous generations of mobility. However, new 5G use cases and the adoption of mm Wave may require more sites and antennas. This may lead to a more efficient network that may paradoxically result in higher emissions without active intervention. A study on network energy saving in NR may justify the need for energy saving.

Network energy saving may be of great importance for environmental sustainability, to reduce environmental impact (greenhouse gas emissions), and for operational cost savings. As 5G is becoming pervasive across industries and geographical areas, handling more advanced services and applications requiring very high data rates (e.g., extended reality (XR)), networks may be denser, use more antennas, have larger bandwidths, and have more frequency bands. The environmental impact of 5G may need to stay under control, and novel solutions to improve network energy savings may need to be developed.

Energy consumption may be a key part of the operators' operation expenditure (OPEX). The energy cost on mobile networks may account for ˜23% of a total operator cost. Most of the energy consumption may come from a radio access network and, in particular, from an active antenna unit (AAU), with data centers and fiber transport accounting for a smaller share. The power consumption of a radio access may be split into two parts: a dynamic part which is only consumed when data transmission and/or reception is ongoing, and a static part which is consumed all the time to maintain the necessary operation of the radio access devices, even when the data transmission and/or reception is not on-going.

Therefore, efficiencies for a network energy consumption model (e.g., especially for the base station, KPIs, an evaluation methodology) may be developed and network energy savings techniques in targeted deployment scenarios may be identified and/or studied. In some systems, there may be more efficient operation dynamically and/or semi-statically and finer granularity adaptation of transmissions and/or receptions in one or more of network energy saving techniques in time, frequency, spatial, and power domains, with potential support and/or feedback from UE, potential UE assistance information, and information exchange and/or coordination over network interfaces.

In various systems, the potential network energy consumption gains may be analyzed, and also the impact on network and user performance may be assessed and balanced (e.g., by looking at key performance indicators (KPIs) such as spectral efficiency, capacity, user perceived throughput (UPT), latency, UE power consumption, complexity, handover performance, call drop rate, initial access performance, service level agreement (SLA) assurance related KPIs, and so forth).

In certain systems, a network expends substantial energy in transmitting synchronization signal blocks (SSBs), physical broadcast channels (PBCHs) (e.g., PBCH containing master information block (MIB), system information block 1 (SIB1), other system information, and paging). The system information blocks (SIBs) apart from SIB1 may be provided on demand. Transmission of SSB and SIB1 may be useful for cell identification, idle and connected mode mobility, and so forth. Energy consumption from constant paging transmissions may be unnecessary, especially if not many (or none) of the UEs being paged are actually present in a cell intending to save energy. Described herein are UE and network methods that enable network energy saving by minimizing paging transmissions.

Some systems spread POs and PFs evenly across time, and this may hinder a RAN node to go to deeper sleep modes as it might need to wake up to send paging even if the paged UEs might not be in the cell coverage area. The location of IDLE mode UEs may only be known at a registration area (e.g., one or more tracking areas received in a registration accept) level. In various systems, the PF and PO are calculated.

For example, the UE may use discontinuous reception (DRX) in RRC_IDLE and RRC_INACTIVE states to reduce power consumption. The UE may monitor one PO per DRX cycle. A PO may be a set of PDCCH monitoring occasions and may include multiple time slots (e.g., subframe or OFDM symbol) where paging DCI can be sent. One PF may be one radio frame and may contain one or multiple POs or a starting point of a PO.

In multi-beam operations, a UE may assume that the same paging message and the same short message are repeated in all transmitted beams and thus the selection of the beams for the reception of the paging message and short message is up to UE implementation. The paging message may be the same for both RAN initiated paging and core network (CN) initiated paging.

The UE may initiate an RRC connection resume procedure upon receiving RAN initiated paging. If the UE receives a CN initiated paging in an RRC_INACTIVE state, the UE moves to the RRC_IDLE state and informs a non-access stratum (NAS).

The PF and PO for paging may be determined by the following formula. A subframe number (SFN) for the PF may be determined by: (SFN+PF_offset) mod T=(T div N)*(UE_ID mod N). Index (i_s), indicating the index of the PO may be determined by: i_s=floor (UE_ID/N) mod Ns.

The PDCCH monitoring occasions for paging may be determined according to pagingSearchSpace and firstPDCCH-MonitoringOccasionOfPO and nrofPDCCH-MonitoringOccasionPerSSB-InPO if configured. When SearchSpaceId=0 is configured for pagingSearchSpace, the PDCCH monitoring occasions for paging may be the same as for remaining minimum system information (RMSI).

When SearchSpaceId=0 is configured for pagingSearchSpace, Ns is either 1 or 2. For Ns=1, there is only one PO which starts from the first PDCCH monitoring occasion for paging in the PF. For Ns=2, PO is either in the first half frame (i_s=0) or the second half frame (i_s=1) of the PF.

When SearchSpaceId other than 0 is configured for pagingSearchSpace, the UE monitors the (i_s+1)th PO. A PO is a set of ‘S*X’ consecutive PDCCH monitoring occasions where ‘S’ is the number of actual transmitted SSBs determined according to ssb-PositionsInBurst in SIB1 and X is the nrofPDCCH-MonitoringOccasionPerSSB-InPO if configured or is equal to 1 otherwise. The [x*S+K]th PDCCH monitoring occasion for paging in the PO corresponds to the Kth transmitted SSB, where x=0, 1, . . . , X−1, K=1, 2, . . . , S. The PDCCH monitoring occasions for paging which do not overlap with UL symbols (determined according to tdd-UL-DL-ConfigurationCommon) are sequentially numbered from zero starting from the first PDCCH monitoring occasion for paging in the PF. When firstPDCCH-MonitoringOccasionOfPO is present, the starting PDCCH monitoring occasion number of (i_s+1)th PO is the (i_s+1)th value of the firstPDCCH-MonitoringOccasionOfPO parameter; otherwise, it is equal to i_s*S*X. If X>1, when the UE detects a PDCCH transmission addressed to P-RNTI within its PO, the UE is not required to monitor the subsequent PDCCH monitoring occasions for this PO.

It should be noted that a PO associated with a PF may start in the PF or after the PF. It should also be noted that the PDCCH monitoring occasions for a PO may span multiple radio frames. When SearchSpaceId other than 0 is configured for paging-SearchSpace the PDCCH monitoring occasions for a PO may span multiple periods of the paging search space.

The following parameters may be used for the calculation of PF and i_s, where T is a DRX cycle of the UE.

If the UE does not operate in extended DRX (eDRX), T is determined by the shortest of the UE specific DRX values, if configured by RRC and/or upper layers or provided in PC5-RRC signaling if an L2 U2N Relay UE, and a default DRX value broadcast in system information. In an RRC_IDLE state, if UE specific DRX is not configured by upper layers, the default value may be applied.

In an RRC_IDLE state, if the UE operates in eDRX and eDRX is configured by upper layers (e.g., TeDRX), CN: if TeDRX, CN is no longer than 1024 radio frames: T=TeDRX, CN; else: during CN configured paging time window (PTW), T is determined by the shortest of UE specific DRX value, if configured by upper layers, and the default DRX value broadcast in system information.

In RRC_INACTIVE state, if the UE operates in eDRX and eDRX is configured by RRC, (e.g., TeDRX, RAN, and/or upper layers): If both TeDRX, CN and used TeDRX, RAN are no longer than 1024 radio frames, T=min {TeDRX, RAN, TeDRX, CN}. If TeDRX, CN is no longer than 1024 radio frames and no TeDRX, RAN is configured or used, T is determined by the shortest of UE specific DRX value configured by RRC and TeDRX, CN.

If TeDRX, CN is longer than 1024 radio frames: If TeDRX, RAN is not configured or used: During CN configured PTW, T is determined by the shortest of the UE specific DRX values, if configured by RRC and/or upper layers, and a default DRX value broadcast in system information. Outside the CN configured PTW, T is determined by the UE specific DRX value configured by RRC; else if used TeDRX, RAN is no longer than 1024 radio frames: During CN configured PTW, T is determined by the shortest of the UE specific DRX value, if configured by upper layers and TeDRX, RAN, and a default DRX value broadcast in system information. Outside the CN configured PTW, T is determined by TeDRX, RAN. N: number of total paging frames in T. Ns: number of paging occasions for a PF. PF_offset: offset used for PF determination. UE_ID: If the UE operates in eDRX: 5G-S-TMSI mod 4096, else: 5G-S-TMSI mod 1024.

Parameters Ns, nAndPagingFrameOffset, nrofPDCCH-MonitoringOccasionPerSSB-InPO, and the length of default DRX Cycle are signaled in SIB1. The values of N and PF_offset are derived from the parameter nAndPagingFrameOffset. The parameter firstPDCCH-MonitoringOccasionOfPO is signalled in SIB1 for paging in the bandwidth part (BWP) configured by initialDownlinkBWP. For paging in a DL BWP other than the BWP configured by initialDownlinkBWP, the parameter first-PDCCH-MonitoringOccasionOfPO is signaled in the corresponding BWP configuration.

If the UE has no 5G-S-TMSI, for instance when the UE has not yet registered onto the network, the UE may use as default identity UE_ID=0 in the PF and i_s formulas. 5G-S-TMSI is a 48 bit long bit string. 5G-S-TMSI may be interpreted as a binary number where the left most bit represents the most significant bit. In RRC_INACTIVE state, if the UE supports inactiveStatePO-Determination and the network broadcasts ranPagingInIdlePO with value “true”, the UE may use the same i_s as for RRC_IDLE state. Otherwise, the UE may determine the i_s based on the parameters and formula herein.

In an RRC_INACTIVE state, if a used eDRX value configured by upper layers is no longer than 1024 radio frames, the UE may use the same i_s as for the RRC_IDLE state. In the RRC_INACTIVE state, if a used eDRX value configured by upper layers is longer than 1024 radio frames, during CN PTW, the UE may use the same i_s as for the RRC_IDLE state. Outside CN PTW, the UE may use the i_s for the RRC_INACTIVE state.

In one possible solution more sporadic (e.g., less occasional) paging frames may be used, which may be done by extending the values of N to have an increased interval between PFs (e.g. T/64, T/128 . . . ) and compensating a decrease in a number of PFs by increasing POs per PF. This however may need as many transmissions from the network since the number of total POs before and after this enhancement remains the same, leading to almost the same energy consumed.

One paging transmission system in 5G NR is over-dimensioned and even if only a few UEs need to be transmitted, it may have to wake up and transmit paging often if the UEs to be paged are listening to paging at different time occasions. Table 1 shows examples of the extent of over dimensioning:

TABLE 1
Example where only 8 Paging records are transmitted on
an average during peak hours in a cell with 2000 UEs

| | |
|---|---|
| Default Paging Cycle | 1.28 |
| N | 16 |
| Ns | 1 |
| Avg #Voice Call + SMSs per hour | 1 |
| Application like whatsApp/Keep alive frequency 1 per | 45 |
| x seconds | |
| Keep Alive (assuming DL) 1/45 seconds | 80 |
| How many Paging per UE per day (24 hrs) | 81 |

| | #UEs in a Cell with a | | |
|---|---|---|---|
| | corresponding paging area | | |
| | 200 | 1000 | 2000 |
| Total number of pagings per hour | 16200 | 81000 | 162000 |
| Number of Paging RRC Messages required | 507 | 2532 | 5063 |
| How many Paging RRC msgs can be sent | 22500 | | |
| every hour | | | |
| Overdimensioned factor | 44 | 8 | 4 |

Table shows that even for large cells with 2000 idle UEs, the paging scheme is 4 times over-dimensioned leading to an average of 8 paging records included in each paging occasion. This is calculated based on highest value of N (e.g., 1/16, meaning only every 16th frame is a paging frame as opposed to every or every second, fourth, etc.) and for Ns=1. For application paging, it may be assumed that some applications transmit data to the UE in DL or at least a keep alive message once every 45 seconds. This may vary from application to application (e.g., Windows sends a keep alive message not more frequently than once per 2 hours).

Certain embodiments may enable paging bundling relying on a more realistic required paging rate. The aim may be to minimize RAN transmission for paging purposes.

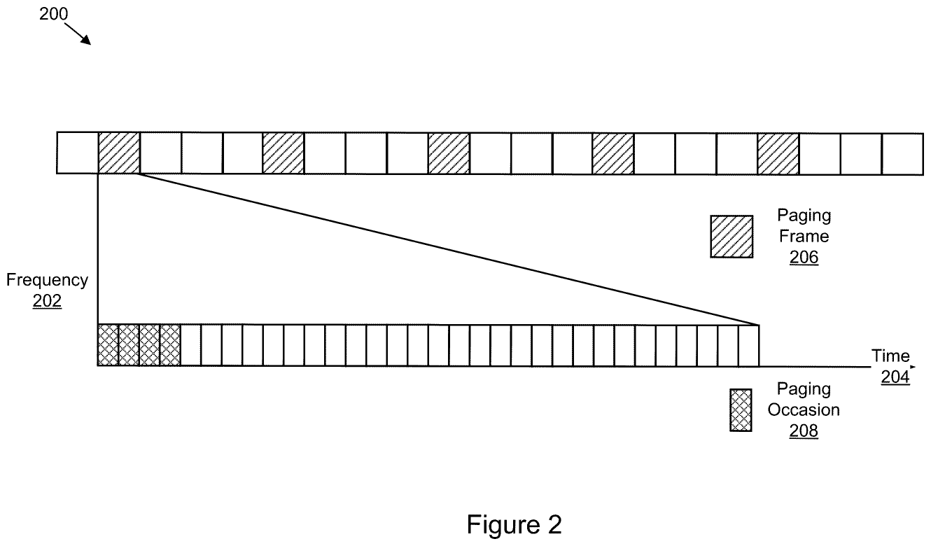

Among the common signals that need to be transmitted even during gNB's idle periods, SSB, SIB, and PRACH transmissions may be adjusted to be as large as 160 msec. While paging periods can be adjusted to happen also at 160 msec, this may be at the expense of reduced paging opportunities. In some systems, Pos and PFs may be spread evenly across time and this may negatively impact a gNB being able to go to deeper sleep modes as the gNB may need to wake up to send paging even if the paged UEs may not be in the cell coverage area. This may be because the network does not know the location of IDLE mode UEs within the paging tracking area, and all cells within the paging tracking area may need to broadcast paging regardless of whether there is a UE that will respond to the paging. FIG. 2 illustrates an example paging frame and occasion when N is configured to T/4, and Ns is configured to 4. When N is set to T/4, the gNB may need to transmit paging every 4 frames.

FIG. 2 illustrates an example diagram 200 of PFs and POs when N=T/4 and Ns=4 in accordance with aspects of the present disclosure. The diagram 200 is illustrated over a frequency 202 and time 204 with PFs 206 and POs 208 illustrated.

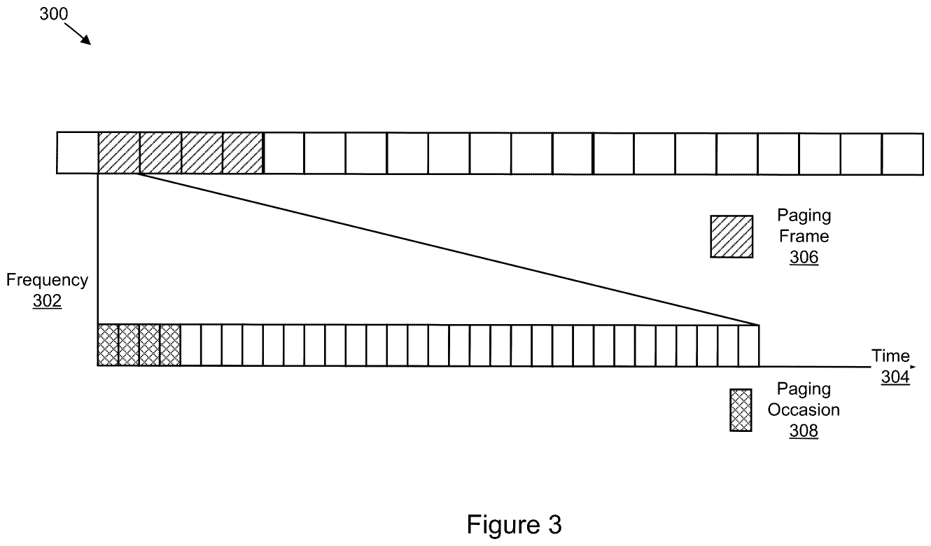

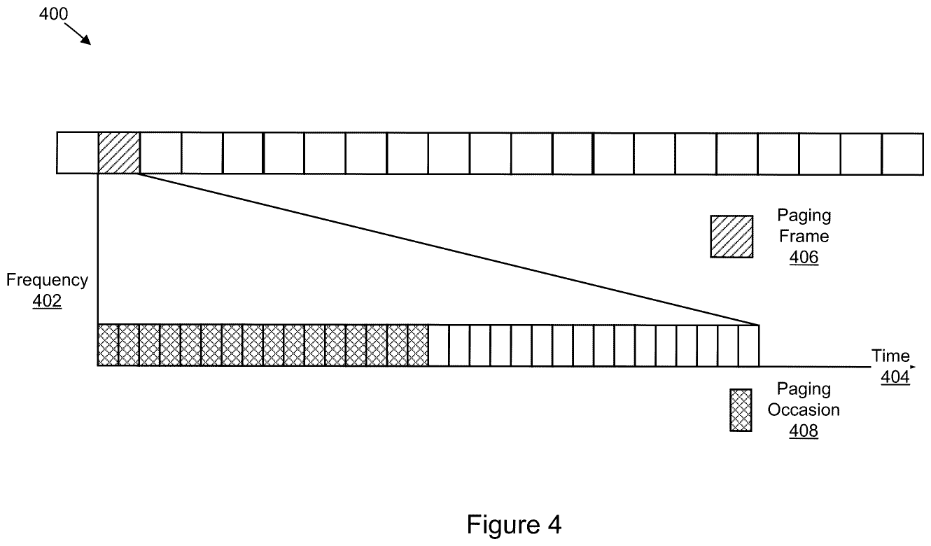

It may be possible to support the same paging transmission density by squeezing the POs to consecutive slots or frames, such that the gNB does not necessarily need to wake up frequently. FIGS. 3 and 4 illustrate some examples of potential enhancements that may be made for paging. FIGS. 3 and 4 illustrate shifting PFs and POs into consecutive frames or slots while maintaining the same paging occasion density.

FIG. 3 illustrates another example diagram 300 of PFs and POs in accordance with aspects of the present disclosure. The diagram 300 is illustrated over a frequency 302 and time 304 with PFs 306 and POs 308 illustrated.

FIG. 4 illustrates a further example diagram 400 of PFs and POs in accordance with aspects of the present disclosure. The diagram 400 is illustrated over a frequency 402 and time 404 with PFs 406 and POs 408 illustrated.

Regarding FIGS. 2 through 4, one source observed that for BS category 1 and at empty load case, statically adapting such paging configurations may provide BS energy savings by 0.2%˜6.7% when paging load (resource used for paging) is 0.2%˜0.5%, and the gain may be up to 42.3% when paging load is increased up to 3.6%. The gain may also increase as the number of SSB increases. Performance of dynamically adapting paging configurations is not provided. The above energy saving gains may be achieved with SSB periodicity of 80 ms or 160 ms. In embodiments described herein, energy saving may be further improved.

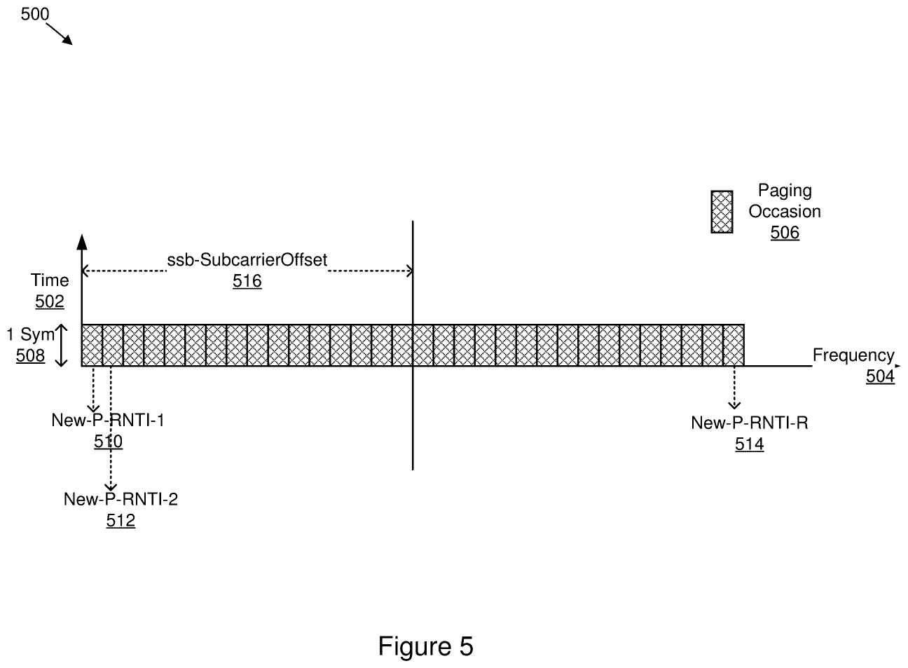

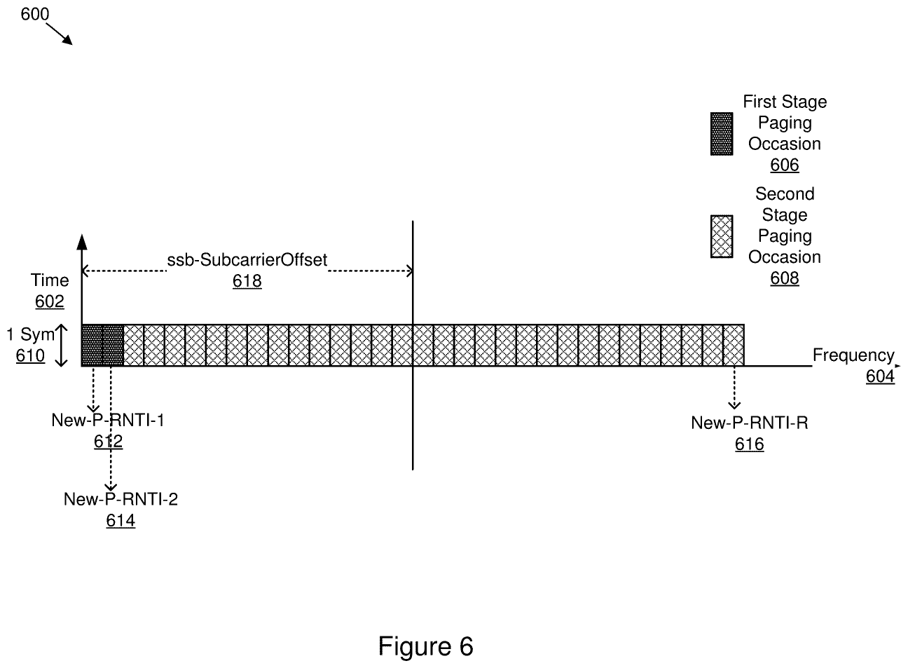

In one embodiment, instead of multiplexing the POs in the time domain, POs are multiplexed in the frequency domain, (or both in the frequency and the time domain) as shown in FIGS. 5 and 6.

FIG. 5 illustrates an example diagram 500 of PFs and POs multiplexed in a frequency domain in accordance with aspects of the present disclosure using a same number of new P-RNTIs. The diagram 500 is illustrated over a time 502 and frequency 504 with POs 506 illustrated over one symbol 508. The new P-RNTIs include a New-P-RNTI-1 510, a New-P-RNTI-2 512, up to a New-P-RNTI-R 514. A ssb-SubcarrierOffset 516 is also illustrated. The POs, and thereby DCIs shown in FIG. 5 can be categorized in two types: firstStage and secondStage, as shown in FIG. 6.

FIG. 6 illustrates an example diagram 600 of PFs and POs multiplexed in a frequency domain with one or more first stage POs and one or more second stage POs in accordance with aspects of the present disclosure. The diagram 600 is illustrated over a time 602 and frequency 604 with first stage POs 606 and second stage POs 608 illustrated over one symbol 610. The new P-RNTIs include a New-P-RNTI-1 612, a New-P-RNTI-2 614, up to a New-P-RNTI-R 616. A ssb-SubcarrierOffset 618 is also illustrated. Each of the firstStage POs and/or DCIs are multiplexed in the frequency domain with cyclic redundancy cycle (CRC) scrambled by a corresponding firstStage-P-RNTI-f[f=1 . . . max_f] that may carry PDSCH resource information of its own. For this purpose, the DCI format 1_0 with CRC scrambled by P-RNTI may be used.

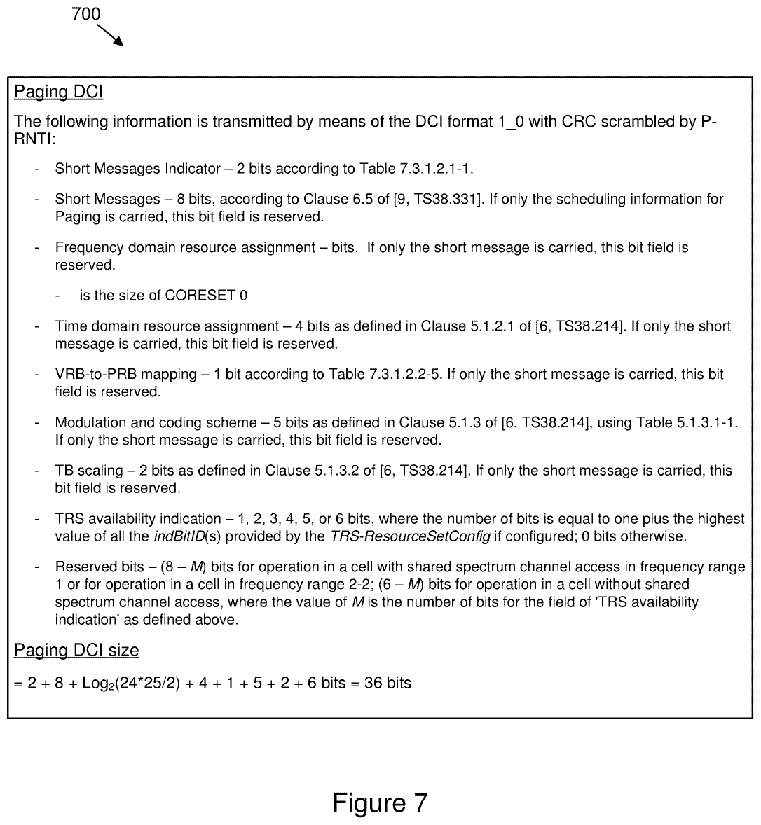

FIG. 7 illustrates an example of paging DCI 700 in accordance with aspects of the present disclosure.

Information called LastBITMAP may be included which is an integer and indicates a number of LastBITMAP that has a paging record for a UE included in RRC paging messages scheduled by the PDSCH resources signaled in the same firstStage-DCI.

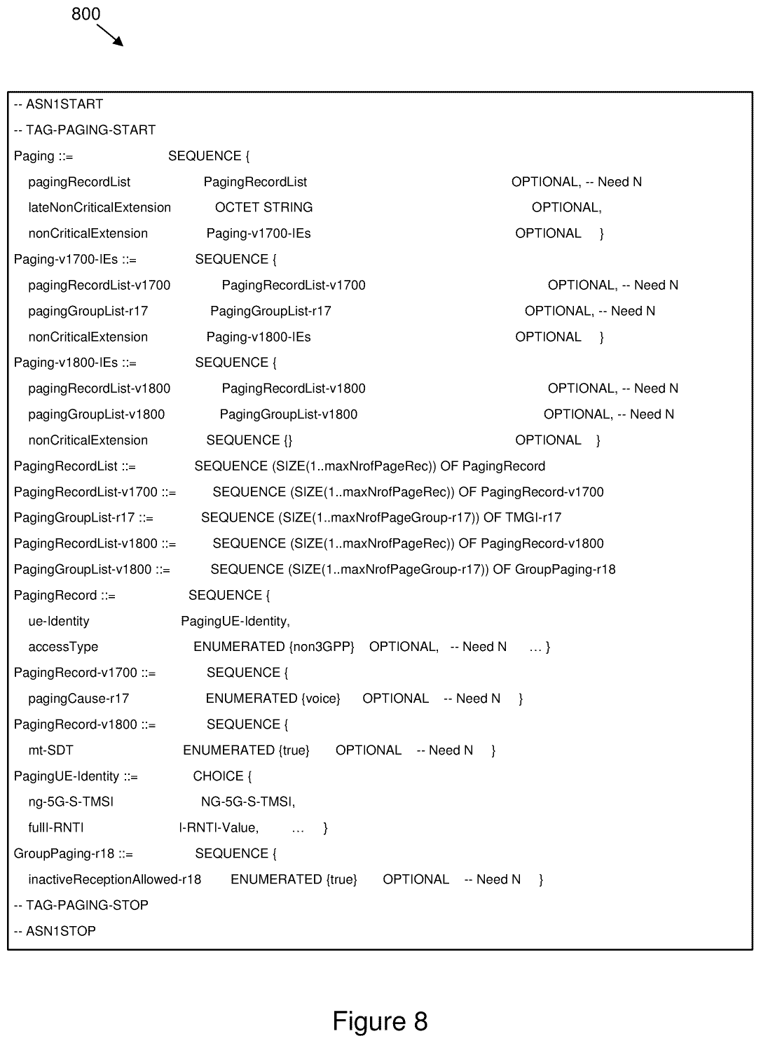

FIG. 8 illustrates an example of an RRC paging message 800 in accordance with aspects of the present disclosure.

Some optimizations may be made such that a next firstStage-PO need not repeat all the content of the previous firstStage-PO (e.g., short messages indicator, short messages and even tracking reference signal (TRS) availability indication). The space created may be used to indicate something else (e.g., a BITMAP, a PEI subgroup ID—where a UE ID based on CN based can be used as in legacy, or a new subgrouping can be done; UE_Id or a MOD value thereof).

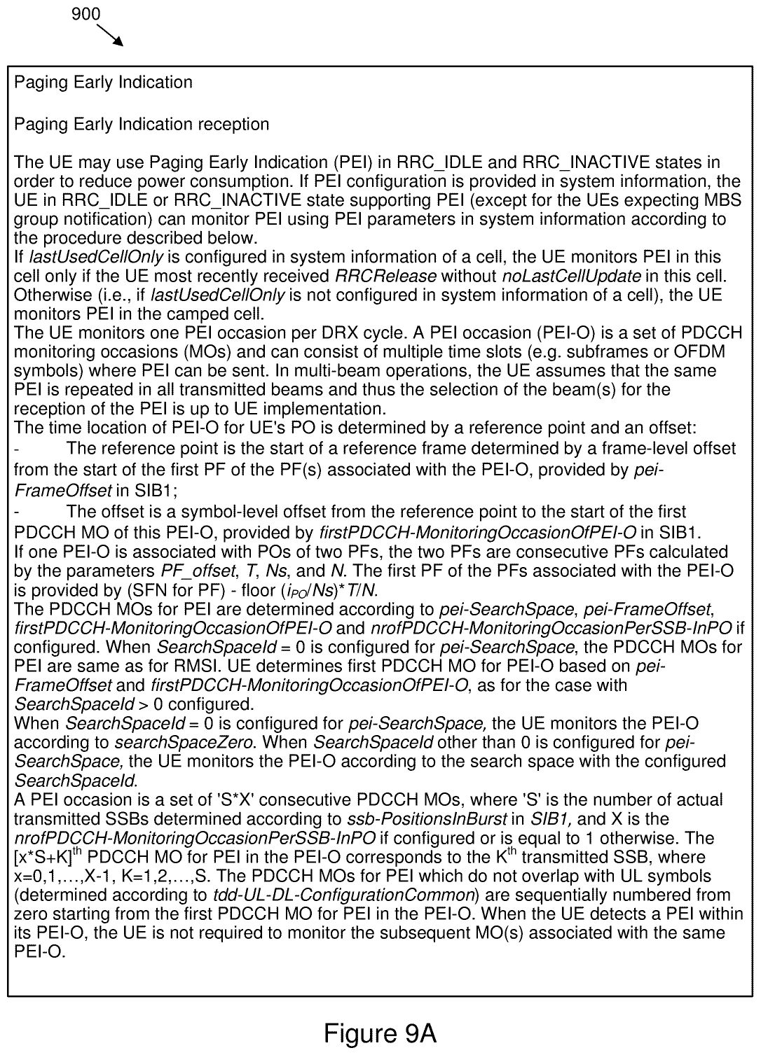

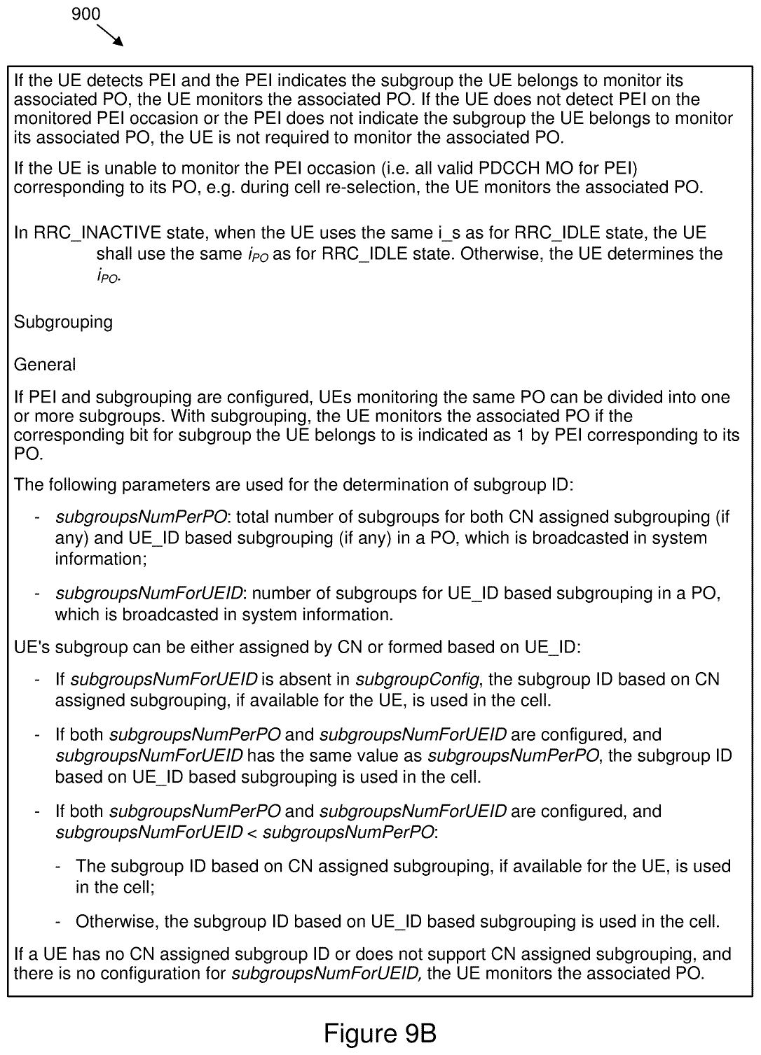

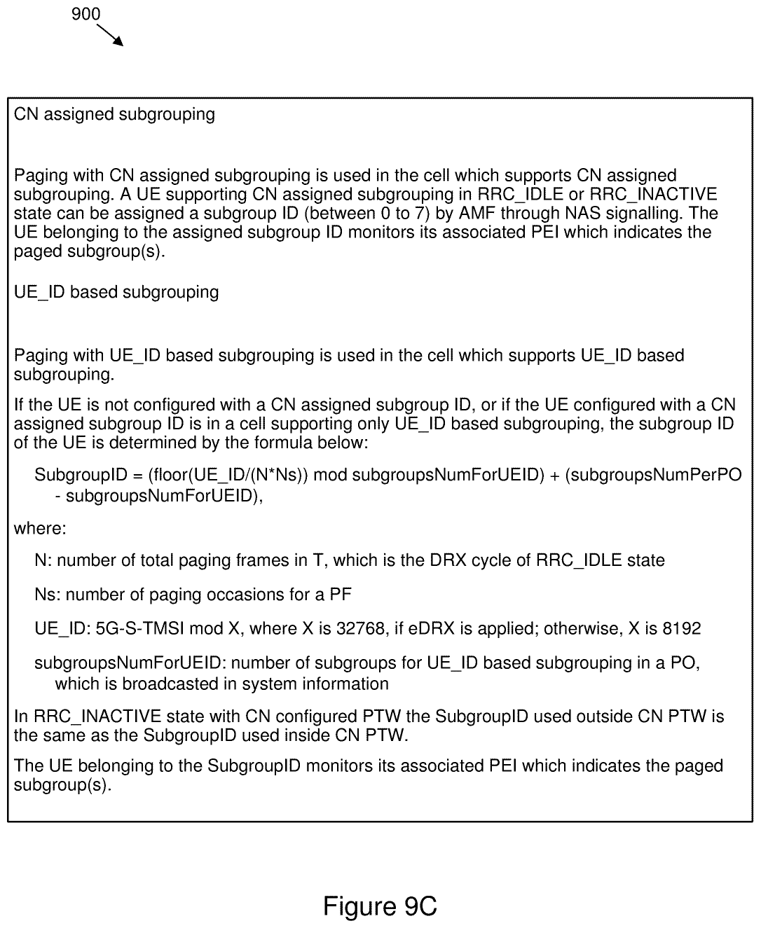

FIGS. 9A, 9B, and 9C illustrate an example of a PEI 900 subgrouping method in accordance with aspects of the present disclosure.

The remaining one or more transmitted POs may be secondStage POs signaling a corresponding secondStage-DCI. Each of the secondStage-DCIs may be multiplexed in the frequency domain with CRC scrambled by a corresponding secondStage-P-RNTI-s [f=1 . . . max_s]. Each of the transmitted secondStage-DCI carries a BITMAP of length ‘B’ bits, where B=1024/(max_s*N-new). The ‘N-new’ is the total number of paging places in a new paging cycle. The new paging cycle may be a default paging cycle and may not depend on the UE specific paging cycles.

TABLE 2
Examples of BITMAP length, number of
required P-RNTIs required and N-new

| BITMAP length | max_s (num secondStage-P-RNTIs) | N-new |
|---|---|---|
| 32 | 32 | 1 |
| 16 | 32 | 2 |
| 32 | 16 | 2 |

Both new DCI types (e.g., firstStage-DCI and secondStage-DCI) may include one bit to indicate if it is first stage DCI or second stage DCI.

A UE will perform UE_ID MOD max_s operation to determine which secondStage-P-RNTI it needs to monitor. Along with this, it may determine the BITMAP index (Bi) as shown in Table 3.

TABLE 3

| | | BITMAP |
|---|---|---|
| UE_ID MOD max_s | secondStage-P-RNTIs | index (Bi) |
| 0 | secondStage-P-RNTI-1 | 1 |
| 1 | secondStage-P-RNTI-2 | 2 |
| . . . | . . . | . . . |
| max_s − 1 | secondStage-P-RNTI-max_s | max_s |

All UEs may receive and store the content of the very first firstStage-DCI for information that may not be repeated in the next firstStage-DCIs. Based on the LastBITMAP information present in the firstStage DCI, the UE determines which firstStage-DCI has the physical downlink shared channel (PDSCH) information relevant for it.

If the value of LastBITMAP is layer 1 (L1) in the very first firstStage-DCI then this (e.g., corresponding PDSCH) carries information for Bi 1 to L1. Similarly, if the value of LastBITMAP is layer 2 (L2) in the next firstStage-DCI then this (e.g., corresponding PDSCH) carries information for L1+1 to L2. The UE may then determine the firstStage-DCI relevant for it such that Lx<=Bi<=Ly.

After this, the UE-x goes on to receive secondStage-DCI corresponding to its determined secondStage-P-RNTI-x, if the DCI is received then it further determines if its BIT position ‘b’ in the BITMAP of length ‘B’ bits included in the secondStage-DCI is set to ‘True’. If so, it uses the PDSCH resource information in ‘its’ firstStage-DCI to receive RRC paging message. To determine if its BIT position ‘b’ in the BITMAP of length ‘B’ bits, it may be calculated as: b=UE_ID Mod B+1. Where, the UE_ID is calculated as: If the UE operates in eDRX: 5G-S-TMSI mod 4096, else: 5G-S-TMSI mod 1024.

After receiving the RRC paging message, the UE determines if its paging record is included. If so, the UE concludes that it is paged and forwards the paging message to an upper layer (e.g., NAS).

Generalizing ‘b’: In the above it is assumed that there's a single UE at the BIT position ‘b’ in the BITMAP of length ‘B’ bits, however, it should be possible to have more than one UEs monitoring the same BIT (UEper-bit). This will allow e.g. reduction in the length of the BITMAP ‘B’ bits and/or number of required reserved secondStage-P-RNTI (max_s) such that:

UEper-bit*B*max_s=1024/New_PONUM, Where New_PONUM is the number of new paging occasions.

All the first and second stage paging DCIs may be reserved. The network may only transmit 0 or more first stage DCIs and 0 or more second stage DCIs depending on if any and how many UEs need to be paged.

The paging scheme (e.g., bundle of 0 or more first stage DCIs and 0 or more second stage DCIs) may be transmitted at one or more of the following time points (e.g., new POs), a total of New_PONUM times: A fixed time point repeated every ‘T’ (e.g., new-default paging cycle), the first fixed time point is defined using a fixed frame, subframe, and/or slot offset.

The PF and PO for paging may be determined as in the following formula:

SFN for the PF are determined by: (SFN+PF_offset)mod T=(T div N)*(UE_ID mod N),Index(i_s),indicating the index of the PO is determined by: i_s=floor(UE_ID/N)mod Ns where UE_ID is taken as a fixed value like ‘0’.

The parameters PF_offset, T and N may either be fixed or configured by system information. The control resource set (CORESET), search space configuration to receive new DCIs may be specified or configured in system information. As an example, a configuration for aggregation Level 4 may be as follows: Number of control channel element (CCE)=4 (24 REG), Size of 1 REG in RE=12, Total Number of available RE=12 subcarriers×1 symbols×24 REG=288, Total number of available physical downlink control channel (PDCCH) RE=288−72=216 (72 REs are used for DMRS), Total number of available bits for the aggregation level=216×2=432 bits (2 comes from bits/QPSK).

So, if 1 first stage DCI and 4 second stage DCIs are used, then 1*36+4*33=168 bits are needed.

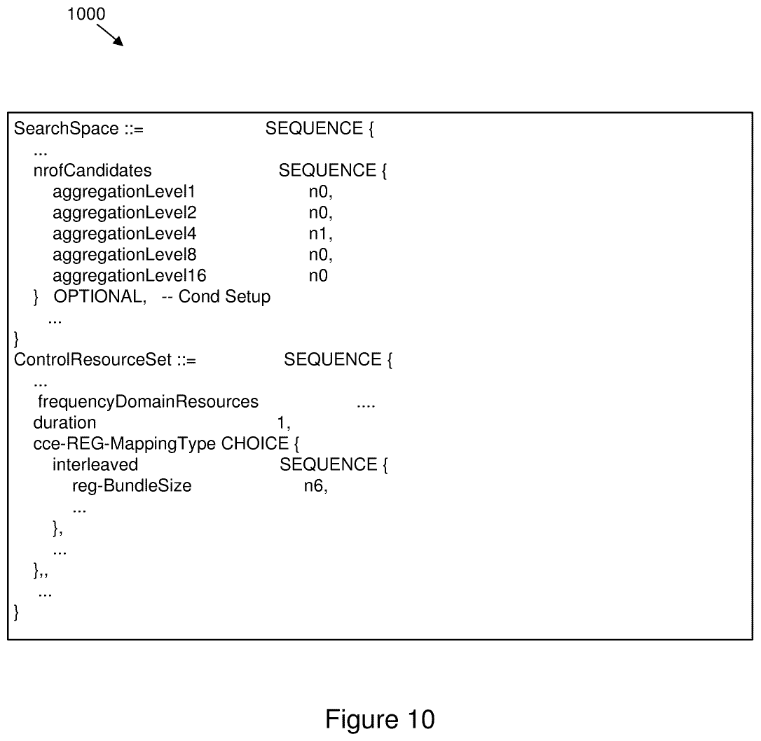

FIG. 10 illustrates an example of a SS configuration 1000 in accordance with aspects of the present disclosure.

The paging scheme described herein may have the following benefits. It may reduce the network's number of required RRC paging message (PDSCH) transmissions. If the network needs to make T*N*Ns transmissions in a paging cycle (T=T ms*100), containing paging for only a single UE at each PO—in the most unfortunate case, now it needs to transmit only one paging RRC message.

Allowing the network to sleep longer since the new scheme is potentially one-shot transmission per paging cycle compared with at least 8 wake ups required in a current scheme. In addition, a new default paging cycle may be stretched beyond 256 radio frames.

One example of a false alarm rate for UEs may also be reduced as shown in Table 4.

TABLE 4
False Alarm rate comparison between a legacy PEI based scheme
(with Ns = 1) and embodiments found herein (new paging scheme)
Paging Early Indication Based Scheme

| | |
|---|---|
| Total number of UE_IDs | 1024 |
| PEI Subgroups (BITMAP) | 8 |
| T (in seconds) | 1.28 |
| T (in #Frames) | 128 |

| | #frames | Num | #UE_IDs | #Num_UE/ | False |
|---|---|---|---|---|---|
| N | in T | PFs | in one PF | BIT | Alarm rate |
| 1 | 128 | 128 | 8 | 1.00 | 0% |
| 0.5 | 128 | 64 | 16 | 2.00 | 50% |
| 0.25 | 128 | 32 | 32 | 4.00 | 75% |
| 0.125 | 128 | 16 | 64 | 8.00 | 88% |
| 0.0625 | 128 | 8 | 128 | 16.00 | 94% |

New Paging Scheme

| | | | |
|---|---|---|---|
| #reserved RNTIs for 2nd stage | 16 | 1 | 0% |
| #New POs | 2 | | |
| BITMAP size | 32 | | |

As Table 4 shows, the false alarm rate may be 94% when N is 1/16 (e.g., paging is sporadic and only every 16th frame is a paging frame). By comparison, when using 16 RNTIs, the false alarm is reduced to 0% when there are two new POs. In both schemes, the false alarm is calculated at the level of UE_ID (e.g., 5G-S-TMSI mod 1024). There may be likely more than 1 UE behind the same UE_ID in the cell and the false alarm may be a factor higher for both schemes. Certain benefits may come at a cost of reserving many RNTIs, but this may be acceptable since the RNTI space is 64000 (2\hat{ }16) (e.g., approximately).

NES R19 is a network energy saving work but if for cell selection UE goes on to request SIB1 for each cell that it comes across after power on or when transitioning to RRC Idle from Connected, or when T311 in running etc., the battery will be diminished by the time a camping might become possible. RAN4 requirements will also not allow the UE so much time for having a sluggish implementation where SIB1 of many NES cells is requested on hit and trial basis. In some cases, the SIB1 request might fail due to say UE geometry, in other cases the SIB1 is acquired but it turns out that the UE may not camp there due to PLMN restriction, forbidden TAs, RAN slicing related issues, or just that after SIB1 acquisition UE determines that the cell selection criteria are not fulfilled. Cellular coverage is very important and even an emergency call can't be initiated if the UE is not yet camped. So, RAN2 should strive to enable the UE to camp in ASAP way. Requesting SIB1 of any and every NES cell for cell selection can lead to unnecessary battery wastage. Stipulated performance requirements may not allow UE so much time for having a sluggish implementation where SIB1 of many NES cells is requested on hit and trial basis. Cell selection should be done on ASAP basis to serve emergency call, if needed. Quite often coverage is very important and even an emergency call can't be initiated if the UE is not yet camped. So, solutions revealed here strive to enable the UE to camp in ASAP way.

In one embodiment, a UE determines if there is a cell for which it does not have to request SIB1—a suitable or even an acceptable cell providing SIB1 in regular broadcast manner can be chosen for camping. UE can request SIB1 of a NES cell only if there's no regular cell available. The performance requirements should be specified accordingly. So, for performing cell selection, UE should consider requesting SIB1 of a NES cell only if there's no “regular” cell (suitable or acceptable) available.

In one embodiment, if the first cell after raw and/or fine frequency scan is determined to be a R19 NES cell, UE has the following choices:

In one implementation, it pauses scan and UE goes on to acquire SIB1 of the first found cell i.e., a cell for which the SSB has been received. If this cell is not broadcasting SIB1 regularly, known from SSB content and is a Rel. 19 NES cell, UE starts sending a request for SIB1.

Alternatively, it looks for other available cells as a result of further frequency scan. Here following implementations are possible:

In one implementation, UE camps on a NES cell only if there's no regular cell available. An NES cell becomes a regular cell as soon as the UE has acquired a valid version of SIB1 of this cell (after the on-demand procedure). But if there's a regular cell available apart from a NES cell, UE considers itself to be camped if the regular cell is suitable or at least acceptable according to definitions and criteria.

Alternatively, in another implementation, UE request SIB1 of NES cells starting from the best NES cell [considering only NES cell(s) above a certain threshold]. After all the SIB1s have been acquired (or not acquired and therefore some cells barred for 300 seconds), normal cell selection decision takes place.

In a further implementation, a new timer is used, and UE attempts to acquire SIB1 of some NES cells providing SIB1 on demand as long as the timer is running. After the timer expiry, UE camps on the best cell for which it can do the legacy ranking, considering all (NES as well as regular) cells for which it has received and processed SIB1 by then.

In one embodiment, UE use legacy principles (“If the serving cell does not fulfil Srxlev>SIntraSearchP and Squal>SIntraSearchQ”) to decide if intra/inter frequency measurements need to be performed. When the UE determines that neighbor cell measurements, intra and/or inter frequency, need to be carried out, it should perform cell ranking using best cell principal. Here, the UE shall first ensure that it has SIB1 of the cells to be ranked ensuring that for best cell principal evaluation, all cells are be compared on the same ground i.e., when related information for all cells including measurement and SIB1 is available. UE may limit requesting SIB1 of cells to only those cells whose SSB quality (RSRP, RSRQ) is better than certain threshold. After this, the UE goes ahead with cell ranking and if the best ranked cell is R19 NES cell UE should go on and request SIB1. Here we assume Network can ensure SIntraSearchP and SIntraSearchQ are sensible to allow time to the UE to acquire SIB1 of NES cell i.e., the network configures these thresholds conservatively to ensure that UE has time to acquire SIB1 from one or more NES cells, once the UE determines that intra/inter frequency measurements need to be performed.

In one enhancement, a new grace period to acquire SIB1, if exceeded the NES cell is barred for 300 seconds.

Alternatively, when the best ranked cell is R19 NES cell, rather than requesting SIB1 for this cell, UE considers the next best ranked cell for reselection, optionally until the SIB1 of the NES cell is acquired. In one enhancement, this behavior could be contingent upon a difference of quality of two cells. In a further optimization, UE implementation can acquire SIB1 of a NES cell anytime, but it should avoid collision with paging occasions of the serving cell i.e., Msg2 and/or MsgB reception time should be away from UE's paging occasion.

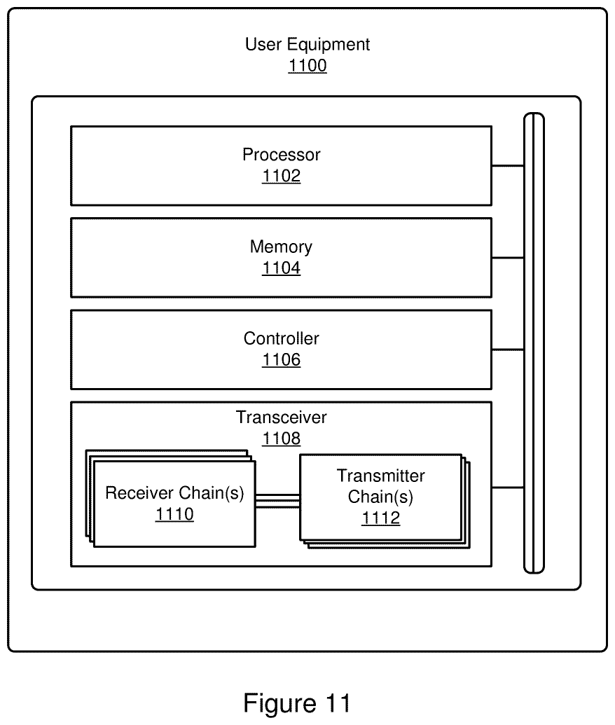

FIG. 11 illustrates an example of a UE 1100 in accordance with aspects of the present disclosure. The UE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1102 may include an intelligent hardware device (e.g., a general-purpose processor, a DSP, a CPU, an ASIC, a field programmable gate array (FPGA), or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the UE 1100 to perform various functions of the present disclosure.

The memory 1104 may include volatile or non-volatile memory. The memory 1104 may store computer-readable, computer-executable code including instructions when executed by the processor 1102 cause the UE 1100 to perform various functions described herein. The code may be stored in a non-transitory computer-readable medium such the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured to cause the UE 1100 to perform one or more of the functions described herein (e.g., executing, by the processor 1102, instructions stored in the memory 1104). For example, the processor 1102 may support wireless communication at the UE 1100 in accordance with examples as disclosed herein. For example, the processor 1102 coupled with the memory 1104 may be configured to cause the UE 1100 to receive one or more first stage DCI and receive a second stage DCI. The UE 1100 may also determine whether a UE bit is set to true in the second stage DCI. The UE 1100 may receive a RRC paging message based on the PDSCH resources included in the one or more first stage DCI. The UE 1100 may also determine whether a paging record of the UE is included in the RRC paging message. The UE 1100 may forward the paging record to an upper layer of the UE in response to determining that paging record of the UE is included in the RRC paging message.

The controller 1106 may manage input and output signals for the UE 1100. The controller 1106 may also manage peripherals not integrated into the UE 1100. In some implementations, the controller 1106 may utilize an operating system such as iOS®, ANDROID®, WINDOWS®, or other operating systems. In some implementations, the controller 1106 may be implemented as part of the processor 1102.

In some implementations, the UE 1100 may include at least one transceiver 1108. In some other implementations, the UE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas for receive the signal over the air or wireless medium. The receiver chain 1110 may include at least one amplifier (e.g., a low-noise amplifier (LNA)) configured to amplify the received signal. The receiver chain 1110 may include at least one demodulator configured to demodulate the receive signal and obtain the transmitted data by reversing the modulation technique applied during transmission of the signal. The receiver chain 1110 may include at least one decoder for decoding the processing the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

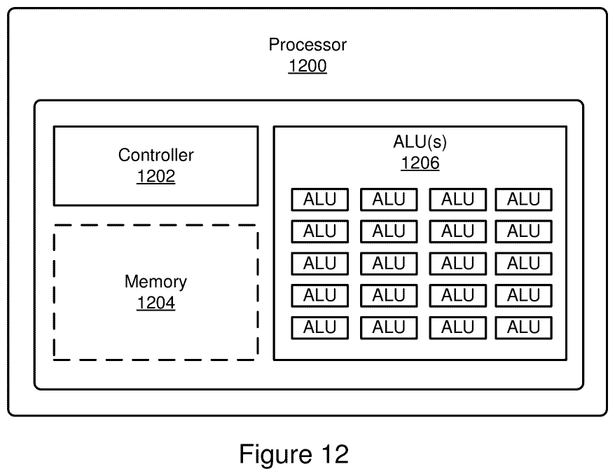

FIG. 12 illustrates an example of a processor 1200 in accordance with aspects of the present disclosure. The processor 1200 may be an example of a processor configured to perform various operations in accordance with examples as described herein. The processor 1200 may include a controller 1202 configured to perform various operations in accordance with examples as described herein. The processor 1200 may optionally include at least one memory 1204, which may be, for example, an L1/L2/L3 cache. Additionally, or alternatively, the processor 1200 may optionally include one or more arithmetic-logic units (ALUs) 1206. One or more of these components may be in electronic communication or otherwise coupled (e.g., operatively, communicatively, functionally, electronically, electrically) via one or more interfaces (e.g., buses).

The processor 1200 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1200) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1202 may be configured to manage and coordinate various operations (e.g., signaling, receiving, obtaining, retrieving, transmitting, outputting, forwarding, storing, determining, identifying, accessing, writing, reading) of the processor 1200 to cause the processor 1200 to support various operations in accordance with examples as described herein. For example, the controller 1202 may operate as a control unit of the processor 1200, generating control signals that manage the operation of various components of the processor 1200. These control signals include enabling or disabling functional units, selecting data paths, initiating memory access, and coordinating timing of operations.

The controller 1202 may be configured to fetch (e.g., obtain, retrieve, receive) instructions from the memory 1204 and determine subsequent instruction(s) to be executed to cause the processor 1200 to support various operations in accordance with examples as described herein. The controller 1202 may be configured to track memory address of instructions associated with the memory 1204. The controller 1202 may be configured to decode instructions to determine the operation to be performed and the operands involved. For example, the controller 1202 may be configured to interpret the instruction and determine control signals to be output to other components of the processor 1200 to cause the processor 1200 to support various operations in accordance with examples as described herein. Additionally, or alternatively, the controller 1202 may be configured to manage flow of data within the processor 1200. The controller 1202 may be configured to control transfer of data between registers, arithmetic logic units (ALUs), and other functional units of the processor 1200.

The memory 1204 may include one or more caches (e.g., memory local to or included in the processor 1200 or other memory, such RAM, ROM, DRAM, SDRAM, SRAM, MRAM, flash memory, etc. In some implementations, the memory 1204 may reside within or on a processor chipset (e.g., local to the processor 1200). In some other implementations, the memory 1204 may reside external to the processor chipset (e.g., remote to the processor 1200).

The memory 1204 may store computer-readable, computer-executable code including instructions that, when executed by the processor 1200, cause the processor 1200 to perform various functions described herein. The code may be stored in a non-transitory computer-readable medium such as system memory or another type of memory. The controller 1202 and/or the processor 1200 may be configured to execute computer-readable instructions stored in the memory 1204 to cause the processor 1200 to perform various functions. For example, the processor 1200 and/or the controller 1202 may be coupled with or to the memory 1204, the processor 1200, the controller 1202, and the memory 1204 may be configured to perform various functions described herein. In some examples, the processor 1200 may include multiple processors and the memory 1204 may include multiple memories. One or more of the multiple processors may be coupled with one or more of the multiple memories, which may, individually or collectively, be configured to perform various functions herein.

The one or more ALUs 1206 may be configured to support various operations in accordance with examples as described herein. In some implementations, the one or more ALUs 1206 may reside within or on a processor chipset (e.g., the processor 1200). In some other implementations, the one or more ALUs 1206 may reside external to the processor chipset (e.g., the processor 1200). One or more ALUs 1206 may perform one or more computations such as addition, subtraction, multiplication, and division on data. For example, one or more ALUs 1206 may receive input operands and an operation code, which determines an operation to be executed. One or more ALUs 1206 be configured with a variety of logical and arithmetic circuits, including adders, subtractors, shifters, and logic gates, to process and manipulate the data according to the operation. Additionally, or alternatively, the one or more ALUs 1206 may support logical operations such as AND, OR, exclusive-OR (XOR), not-OR (NOR), and not-AND (NAND), enabling the one or more ALUs 1206 to handle conditional operations, comparisons, and bitwise operations.

The processor 1200 may support wireless communication in accordance with examples as disclosed herein. The processor 1200 may be configured to or operable to support a means for: receiving one or more first stage DCI, receiving a second stage DCI, determining whether a UE bit is set to true in the second stage DCI, determining PDSCH resources from the one or more first stage DCI, receiving a RRC paging message based on the PDSCH resources included in the one or more first stage DCI, determining whether a paging record of the UE is included in the RRC paging message, and forwarding the paging record to an upper layer of the UE in response to determining that paging record of the UE is included in the RRC paging message.

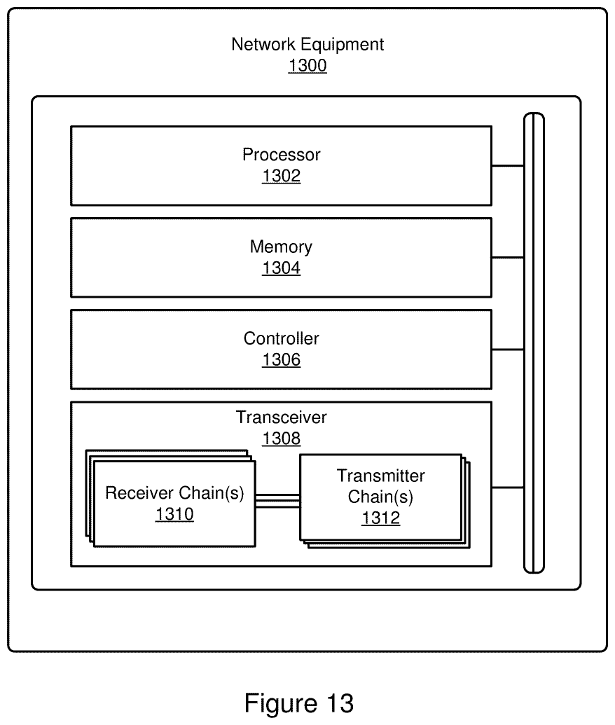

FIG. 13 illustrates an example of a NE 1300 in accordance with aspects of the present disclosure. The NE 1300 may include a processor 1302, a memory 1304, a controller 1306, and a transceiver 1308. The processor 1302, the memory 1304, the controller 1306, or the transceiver 1308, or various combinations thereof or various components thereof may be examples of means for performing various aspects of the present disclosure as described herein. These components may be coupled (e.g., operatively, communicatively, functionally, electronically, electrically) via one or more interfaces.

The processor 1302, the memory 1304, the controller 1306, or the transceiver 1308, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1302 may include an intelligent hardware device (e.g., a general-purpose processor, a DSP, a CPU, an ASIC, an FPGA, or any combination thereof). In some implementations, the processor 1302 may be configured to operate the memory 1304. In some other implementations, the memory 1304 may be integrated into the processor 1302. The processor 1302 may be configured to execute computer-readable instructions stored in the memory 1304 to cause the NE 1300 to perform various functions of the present disclosure. For example, the processor 1302 coupled with the memory 1304 may be configured to cause the NE 1300 to: transmit system information comprising one or more of: a paging frame offset, a default paging cycle length of a default paging cycle, and a number of total paging frames in the default paging cycle, transmit one or more first stage DCI, transmit a second stage DCI, and transmit a RRC paging message based on PDSCH resources included in the one or more first stage DCI.

The memory 1304 may include volatile or non-volatile memory. The memory 1304 may store computer-readable, computer-executable code including instructions when executed by the processor 1302 cause the NE 1300 to perform various functions described herein. The code may be stored in a non-transitory computer-readable medium such the memory 1304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1302 and the memory 1304 coupled with the processor 1302 may be configured to cause the NE 1300 to perform one or more of the functions described herein (e.g., executing, by the processor 1302, instructions stored in the memory 1304). For example, the processor 1302 may support wireless communication at the NE 1300 in accordance with examples as disclosed herein.

The controller 1306 may manage input and output signals for the NE 1300. The controller 1306 may also manage peripherals not integrated into the NE 1300. In some implementations, the controller 1306 may utilize an operating system such as iOS®, ANDROID®, WINDOWS®, or other operating systems. In some implementations, the controller 1306 may be implemented as part of the processor 1302.

In some implementations, the NE 1300 may include at least one transceiver 1308. In some other implementations, the NE 1300 may have more than one transceiver 1308. The transceiver 1308 may represent a wireless transceiver. The transceiver 1308 may include one or more receiver chains 1310, one or more transmitter chains 1312, or a combination thereof.

A receiver chain 1310 may be configured to receive signals (e.g., control information, data, packets) over a wireless medium. For example, the receiver chain 1310 may include one or more antennas for receive the signal over the air or wireless medium. The receiver chain 1310 may include at least one amplifier (e.g., a low-noise amplifier (LNA)) configured to amplify the received signal. The receiver chain 1310 may include at least one demodulator configured to demodulate the receive signal and obtain the transmitted data by reversing the modulation technique applied during transmission of the signal. The receiver chain 1310 may include at least one decoder for decoding the processing the demodulated signal to receive the transmitted data.

A transmitter chain 1312 may be configured to generate and transmit signals (e.g., control information, data, packets). The transmitter chain 1312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1312 may also include at least one power amplifier configured to amplify the modulated signal to an appropriate power level suitable for transmission over the wireless medium. The transmitter chain 1312 may also include one or more antennas for transmitting the amplified signal into the air or wireless medium.

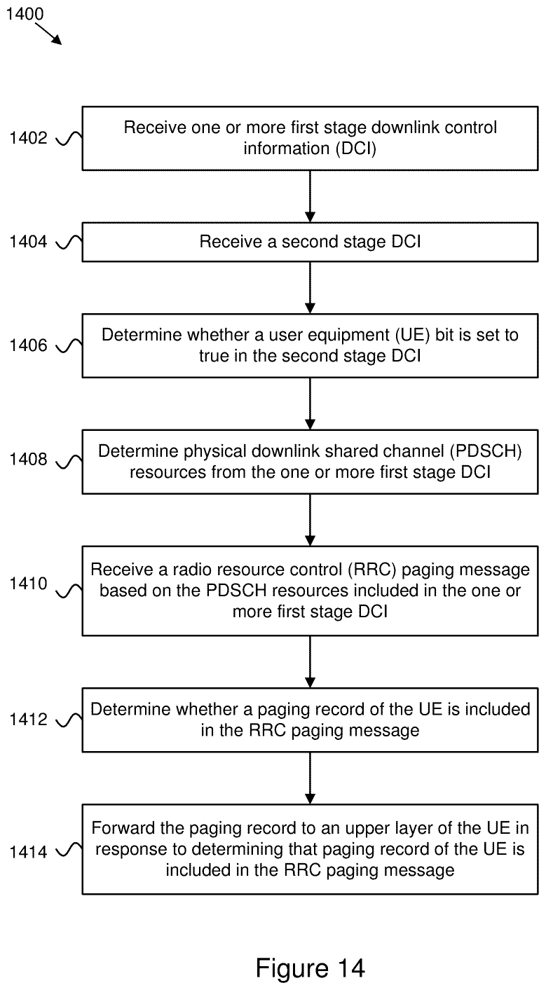

FIG. 14 illustrates a flowchart of a method 1400 in accordance with aspects of the present disclosure. The operations of the method 1400 may be implemented by a UE as described herein. In some implementations, a UE 1100 may execute a set of instructions to control the function elements of a processor to perform the described functions.

At 1402, the method may include receiving one or more first stage DCI. The operations of 1402 may be performed in accordance with examples as described herein. In some implementations, aspects of the operations of 1402 may be performed by a UE as described with reference to FIG. 11.

At 1404, the method may include receiving a second stage DCI. The operations of 1404 may be performed in accordance with examples as described herein. In some implementations, aspects of the operations of 1404 may be performed by a UE as described with reference to FIG. 11.

At 1406, the method may include determining whether a UE bit is set to true in the second stage DCI. The operations of 1406 may be performed in accordance with examples as described herein. In some implementations, aspects of the operations of 1406 may be performed by a UE as described with reference to FIG. 11.

At 1408, the method may include determining PDSCH resources from the one or more first stage DCI. The operations of 1408 may be performed in accordance with examples as described herein. In some implementations, aspects of the operations of 1408 may be performed by a UE as described with reference to FIG. 11.

At 1410, the method may include receiving a RRC paging message based on the PDSCH resources included in the one or more first stage DCI. The operations of 1410 may be performed in accordance with examples as described herein. In some implementations, aspects of the operations of 1410 may be performed by a UE as described with reference to FIG. 11.

At 1412, the method may include determining whether a paging record of the UE is included in the RRC paging message. The operations of 1412 may be performed in accordance with examples as described herein. In some implementations, aspects of the operations of 1412 may be performed by a UE as described with reference to FIG. 11.

At 1414, the method may include forwarding the paging record to an upper layer of the UE in response to determining that paging record of the UE is included in the RRC paging message. The operations of 1414 may be performed in accordance with examples as described herein. In some implementations, aspects of the operations of 1414 may be performed by a UE as described with reference to FIG. 11.

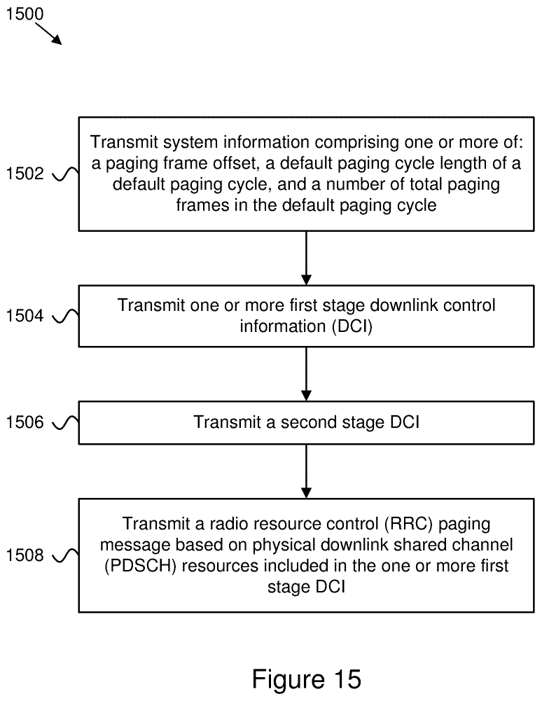

FIG. 15 illustrates a flowchart of another method 1500 in accordance with aspects of the present disclosure. The operations of the method 1500 may be implemented by a NE as described herein. In some implementations, a NE 1300 may execute a set of instructions to control the function elements of a processor to perform the described functions.

At 1502, the method may include transmitting system information comprising one or more of: a paging frame offset, a default paging cycle length of a default paging cycle, and a number of total paging frames in the default paging cycle. The operations of 1502 may be performed in accordance with examples as described herein. In some implementations, aspects of the operations of 1502 may be performed by a NE as described with reference to FIG. 13.

At 1504, the method may include transmitting one or more first stage DCI. The operations of 1504 may be performed in accordance with examples as described herein. In some implementations, aspects of the operations of 1504 may be performed by a NE as described with reference to FIG. 13.

At 1506, the method may include transmitting a second stage DCI. The operations of 1506 may be performed in accordance with examples as described herein. In some implementations, aspects of the operations of 1506 may be performed by a NE as described with reference to FIG. 13.

At 1508, the method may include transmitting a RRC paging message based on PDSCH resources included in the one or more first stage DCI. The operations of 1508 may be performed in accordance with examples as described herein. In some implementations, aspects of the operations of 1508 may be performed by a NE as described with reference to FIG. 13.

It should be noted that the methods described herein describe possible implementations, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
at least one memory; and
at least one processor coupled with the at least one memory and configured to cause the UE to:
receive one or more first stage downlink control information (DCI);
receive a second stage DCI;
determine whether a UE bit is set to true in the second stage DCI;
determine physical downlink shared channel (PDSCH) resources from the one or more first stage DCI;
receive a radio resource control (RRC) paging message based on the PDSCH resources included in the one or more first stage DCI;
determine whether a paging record of the UE is included in the RRC paging message; and
forward the paging record to an upper layer of the UE in response to determining that paging record of the UE is included in the RRC paging message.

2. The UE of claim 1, wherein the one or more first stage DCI is received using a first stage paging radio network temporary identifier (P-RNTI) and the second stage DCI is received using a second stage P-RNTI.

3. The UE of claim 1, wherein the one or more first stage DCI includes the PDSCH resources for carrying the RRC paging message.

4. The UE of claim 1, wherein the second stage DCI is determined using a UE identifier (UE_ID).

5. The UE of claim 1, wherein a bit indicates whether a DCI is the one or more first stage DCI or the second stage DCI.

6. The UE of claim 1, wherein a bitmap index indicates an identity of the second stage DCI.

7. The UE of claim 1, wherein the at least one processor is configured to cause the UE to receive system information comprising one or more of: a paging frame offset, a default paging cycle length of a default paging cycle, and a number of total paging frames in the default paging cycle.

8. The UE of claim 7, wherein the system information is transmitted using a DCI format with a cyclic redundancy cycle scrambled by P-RNTI.

9. A processor for wireless communication, comprising:
at least one controller coupled with at least one memory and configured to cause the processor to:
receive one or more first stage downlink control information (DCI);
receive a second stage DCI;
determine whether a user equipment (UE) bit is set to true in the second stage DCI;
determine physical downlink shared channel (PDSCH) resources from the one or more first stage DCI;
receive a radio resource control (RRC) paging message based on the PDSCH resources included in the one or more first stage DCI;
determine whether a paging record of the UE is included in the RRC paging message; and
forward the paging record to an upper layer of the UE in response to determining that paging record of the UE is included in the RRC paging message.

10. The processor of claim 9, wherein the one or more first stage DCI is received using a first stage paging radio network temporary identifier (P-RNTI) and the second stage DCI is received using a second stage P-RNTI.

11. The processor of claim 9, wherein the one or more first stage DCI includes the PDSCH resources for carrying the RRC paging message.

12. The processor of claim 9, wherein the second stage DCI is determined using a UE identifier (UE_ID).

13. The processor of claim 9, wherein a bit indicates whether a DCI is the one or more first stage DCI or the second stage DCI.

14. A method performed by a user equipment (UE), the method comprising:
receiving one or more first stage downlink control information (DCI);
receiving a second stage DCI;
determining whether a UE bit is set to true in the second stage DCI;
determining physical downlink shared channel (PDSCH) resources from the one or more first stage DCI;
receiving a radio resource control (RRC) paging message based on the PDSCH resources included in the one or more first stage DCI;
determining whether a paging record of the UE is included in the RRC paging message; and
forwarding the paging record to an upper layer of the UE in response to determining that paging record of the UE is included in the RRC paging message.

15. A base station, comprising:
at least one memory; and
at least one processor coupled with the at least one memory and configured to cause the base station to:
transmit system information comprising one or more of: a paging frame offset, a default paging cycle length of a default paging cycle, and a number of total paging frames in the default paging cycle;
transmit one or more first stage downlink control information (DCI);
transmit a second stage DCI; and
transmit a radio resource control (RRC) paging message based on physical downlink shared channel (PDSCH) resources included in the one or more first stage DCI.

16. The base station of claim 15, wherein the one or more first stage DCI is transmitted using a first stage paging radio network temporary identifier (P-RNTI) and the second stage DCI is transmitted using a second stage P-RNTI.

17. The base station of claim 15, wherein the one or more first stage DCI includes the PDSCH resources for carrying the RRC paging message.

18. The base station of claim 15, wherein the second stage DCI is determined using a UE identifier (UE_ID).

19. The base station of claim 15, wherein a bit indicates whether a DCI is the one or more first stage DCI or the second stage DCI.

20. The base station of claim 15, wherein a bitmap index indicates an identity of the second stage DCI.
